(19) United States
(12) Patent Application Publication
(10) Pub. No.: US 2024/0028869 A1
(43) Pub. Date: Jan. 25, 2024

(54) RECONFIGURABLE PROCESSING ELEMENTS FOR ARTIFICIAL INTELLIGENCE ACCELERATORS AND METHODS FOR OPERATING THE SAME

(71) Applicant: Taiwan Semiconductor Manufacturing Company, Ltd., Hsinchu (TW)

(72) Inventors: Xiaoyu Sun, San Jose, CA (US); Rawan Naous, Pleasanton (LB); Murat Kerem Akarvardar, Hsinchu City (TW)

(73) Assignee: Taiwan Semiconductor Manufacturing Company, Ltd., Hsinchu (TW)

(21) Appl. No.: 17/870,053

(22) Filed: Jul. 21, 2022

(51) Int. Cl. G06N 3/04

(52) U.S. Cl. CPC G06N 3/0445

(57) ABSTRACT

A reconfigurable processing circuit of an AI accelerator and a method of operating the same are disclosed. In one aspect, the reconfigurable processing circuit includes a first memory configured to store an input activation state, a second memory configured to store a weight, a multiplier configured to multiply the weight and the input activation state and output a product, a first multiplexer (mux) configured to, based on a first selector, output a previous sum from a previous reconfigurable processing element, a third memory configured to store a first sum, a second mux configured to, based on a second selector, output the previous sum or the first sum, an adder configured to add the product and the previous sum or the first sum to output a second sum, and a third mux configured to, based on a third selector, output the second sum or the previous sum.

### BACKGROUND

Artificial intelligence (AI) is a powerful tool that can be used to simulate human intelligence in machines that are programmed to think and act like humans. AI can be used in a variety of applications and industries. AI accelerators are hardware devices that are used for efficient processing of AI workloads like neural networks. One type of AI accelerator includes a systolic array that can perform operations on inputs via multiplication and accumulate operations.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example block diagram of a processing core of an AI accelerator, in accordance with some embodiments.

FIG. 2 illustrates an example block diagram of a PE, in accordance with some embodiments.

FIGS. 3, 4, and 5 illustrate a PE that is configured for the output stationary flow, in accordance with some embodiments.

FIGS. 6, 7, and 8 illustrate a PE that is configured for the input stationary flow, in accordance with some embodiments.

FIGS. 9, 10, and 11 illustrate a PE that is configured for the weight stationary flow, in accordance with some embodiments.

FIG. 12 illustrates a block diagram of a processing core including a 2×2 PE array, in accordance with some embodiments.

FIG. 13 illustrates a block diagram of an AI accumulator including an array of processing cores, in accordance with some embodiments.

FIG. 14 illustrates a graph of an accuracy loss as a function of accumulator bit width, in accordance with some embodiments.

FIG. 15 illustrates a flowchart of an example method of operating a reconfigurable processing element for an AI accelerator, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over, or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

An AI accelerator is a class of specialized hardware to accelerate machine learning workloads for deep neural network (DNN) processing, which are typically neural networks that involve massive memory accesses and highly-parallel but simple computations. An AI accelerators can be based on application-specific integrated circuits (ASIC) which include multiple processing elements (PEs) (or processing circuits) arranged spatially or temporally to perform the multiply-and-accumulate (MAC) operation. The MAC operation is performed based on input activation states (inputs) and weights, and then summed together to provide output activation stations (outputs). Typical AI accelerators are customized to support one fixed dataflow such as output stationary, input stationary, and weight stationary workflows. However, AI workloads include a variety of layer types/shapes that may favor different dataflows, e.g., one dataflow that fits one workload, or one layer may not be the optimal solution for the others thus limiting the performance. Given the diversity of the workloads in terms of layer type, layer shape, and batch size, one dataflow that fits one workload or one layer may not be the optimal solution for the others thus limiting the performance.

The present embodiments include novel systems and methods of reconfiguring processing elements (PEs) within the AI accelerator to support various dataflows and better adapt to different workloads can boost the efficiency of the AI accelerator. The PEs may include several multiplexors (mux) that can be used to provide the inputs, weights, and partial/full sums for the various dataflows. Various control signals can be used to control the muxes so that the muxes output the data to support each of the dataflows. There is a practical application in that, among other things, the AI accelerator having a reconfigurable architecture may support various dataflows, which can lead to a more energy efficient system and faster calculations performed by the AI accelerator. For example, an approximation accumulation for output stationary dataflow can reduce area and energy overhead by using lower precisions of adder and registers inside the PEs without reducing accuracy. Also, by reusing the standalone accumulators designated for weigh stationary and input stationary dataflows in the PEs to collect partial sums from each core, the disclosed technology also provides technical advantages over conventional systems due to a reduction in area and energy consumption in performing the calculation.

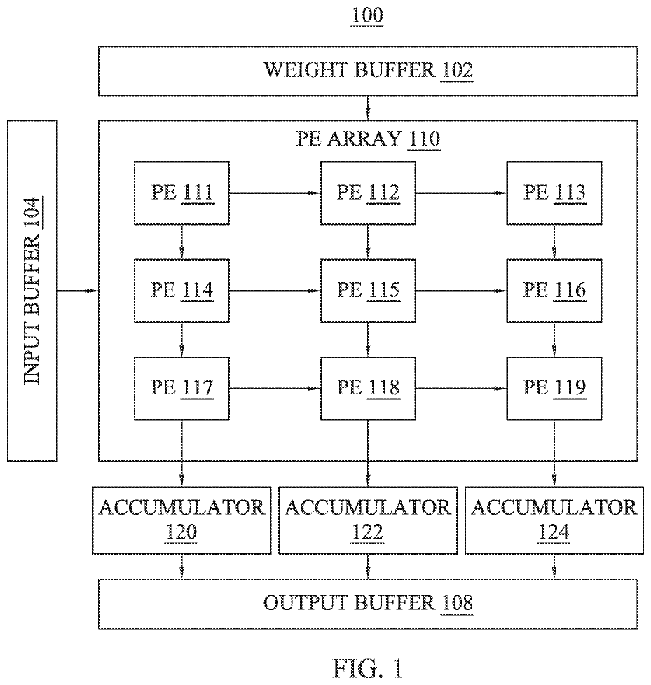

FIG. 1 illustrates an example block diagram of a processing core 100 of an AI accelerator, in accordance with some embodiments. The processing core 100 can be used as a building block for the AI accelerator. The processing core 100 includes a weight buffer 102, an input buffer 104, an output buffer 108, a PE array 110, and accumulators 120, 122, and 124. Although certain components are shown in FIG. 1, embodiments are not limited thereto, and more or fewer components may be included in the processor core 100.

Inner layers of a neural network can largely be viewed as layers of neurons that each receive weighted outputs from the neurons of other (e.g., preceding) layer(s) of neurons in a mesh-like interconnection structure between layers. The weight of the connection from the output of a particular preceding neuron to the input of another subsequent neuron is set according to the influence or effect that the preceding neuron is to have on the subsequent neuron. The output value of the preceding neuron is multiplied by the weight of its connection to the subsequent neuron to determine the particular stimulus that the preceding neuron presents to the subsequent neuron.

A neuron's total input stimulus corresponds to the combined stimulation of all of its weighted input connections. According to various implementations, if a neuron's total input stimulus exceeds some threshold, the neuron is triggered to perform linear or non-linear mathematical function on its input stimulus. The output of the mathematical function corresponds to the output of the neuron which is subsequently multiplied by the respective weights of the neuron's output connections to its following neurons.

Generally, the more connections between neurons, the more neurons per layer and/or the more layers of neurons, the greater the intelligence the network is capable of achieving. As such, neural networks for actual, real-world artificial intelligence applications are generally characterized by large numbers of neurons and large numbers of connections between neurons. Extremely large numbers of calculations (not only for neuron output functions but also weighted connections) are therefore involved in processing information through a neural network.

As mentioned above, although a neural network can be completely implemented in software as program code instructions that are executed on one or more traditional general purpose central processing unit (CPU) or graphics processing unit (GPU) processing cores, the read/write activity between the CPU/GPU core(s) and system memory that is needed to perform all the calculations is extremely intensive. The overhead and energy associated with repeatedly moving large amounts of read data from system memory, processing that data by the CPU/GPU cores and then writing resultants back to system memory, across the many millions or billions of computations needed to effect the neural network have not been entirely satisfactory in many aspects.

Referring to FIG. 1, the processing core 100 represents a building block of a systolic array-based AI accelerator that models a neural network. In systolic array-based systems, data is processed in waves through processing cores 100 which perform computations. These computations sometimes may rely on the computation of dot-products and absolute difference of vectors, typically computed with multiply-accumulate (MAC) operations performed on the parameters, input data and weights. MAC operations generally include the multiplication of two values, and the accumulation of a sequence of multiplications. One or more processing cores 100 can be connected together to form the neural network that may form a systolic array-based system that forms an AI accelerator.

The input buffer 104 includes one or more memories (e.g., registers) that can receive and store inputs (e.g., input activation data) for the neural network. For example, these inputs can be received as outputs from, e.g., a different processing core 100 (not shown), a global buffer (not shown), or a different device. The inputs from the input buffer 104 may be provided to the PE array 110 for processing as described below.

The weight buffer 102 includes one or more memories (e.g., registers) that can receive and store weights for a neural network. The weight buffer 102 may receive and store weights from, e.g., a different processing core 100 (not shown), a global buffer (not shown), or a different device. The weights from the weight buffer 102 may be provided to the PE array 110 for processing as described below.

The PE array 110 includes PEs 111, 112, 113, 114, 115, 116, 117, 118, and 119 arranged in rows and columns. The first row includes PEs 111-113, the second row includes PEs 114-116, and the third row includes PEs 117-119. The first column includes PEs 111, 114, 117, the second column includes PEs 112, 115, 118, and the third row includes PEs 113, 116, 119. Although the processing core 100 includes 9 PEs 111-119, embodiments are not limited thereto and the processing core 100 may include more or fewer PEs. The PEs 111-119 may perform multiplication and accumulation (e.g., summation) operations based on inputs and weights that are received and/or stored in the input buffer 104, weight buffer 102, or received from a different PE (e.g., PE 111-119). The output of a PE (e.g., PE 111) may be provided to one or more different PEs (e.g., PE 112, 114) in the same PE array 110 for multiplication and/or summation operations.

For example, the PE 111 may receive a first input from the input buffer 104 and a first weight from the weight buffer 102 and perform multiplication and/or summation operations based on the first input and first weight. The PE 112 may receive the output of the PE 111 and a second weight from weight buffer 102 and perform multiplication and/or summation operations based on the output of the PE 111 and the second weight. The PE 113 may receive the output of the PE 112 and a third weight from weight buffer 102 and perform multiplication and/or summation operations based on the output of the PE 112 and the third weight. The PE 114 may receive the output of the PE 111, a second input from the input buffer 104 and a fourth weight from weight buffer 102 and perform multiplication and/or summation operations based on the output of the PE 111, the second input, and the fourth weight. The PE 115 may receive the outputs of PEs 112 and 114 and a fifth weight from the weight buffer 102 and perform multiplication and/or summation operations based on the outputs of the PEs 112 and 114 and the fifth weight. The PE 116 may receive the outputs of PEs 113 and 115 and a sixth weight from the weight buffer 102 and perform multiplication and/or summation operations based on the outputs of the PEs 113 and 115 and the sixth weight. The PE 117 may receive the output of the PE 114, a third input from the input buffer 104 and a seventh weight from weight buffer 102 and perform multiplication and/or summation operations based on the output of the PE 114, the third input, and the seventh weight. The PE 118 may receive the outputs of PEs 115 and 117 and a eighth weight from the weight buffer 102 and perform multiplication and/or summation operations based on the outputs of the PEs 115 and 117 and the eighth weight. The PE 119 may receive the outputs of PEs 116 and 118 and a ninth weight from the weight buffer 102 and perform multiplication and/or summation operations based on the outputs of the PEs 116 and 118 and the ninth weight. For a bottom row of PEs of the PE array (e.g., PEs 117-119), the outputs may also be provided to one or more accumulators 120-124. Depending on embodiments, the first, second, and/or third inputs and/or the first to ninth weights and/or the outputs of the PEs 111-119 may be forwarded to some or all of the PEs 111-119. These operations may be performed in parallel such that the outputs from the PEs 111-119 are provided every cycle.

The accumulators 120-124 may sum the partial sum values of the results of the PE array 110. For example, the accumulator 120 may sum the three outputs provided by the PE 117 for a set of inputs provided by the input buffer 104. Each of the accumulators 120-124 may include one or more registers that store the outputs from the PEs 117-119 and a counter that keeps track of how many times the accumulation operation has been performed, before outputting the total sum to the output buffer 108. For example, the accumulator 120 may perform summation operation of the output of PE 117 three times (e.g., to account for the outputs from the three PEs 111, 114, 117) before the accumulator 120 provides the sum to the output buffer 108. Once the accumulators 120-124 finish summing all of the partial values, outputs may be provided to the output buffer 108.

The output buffer 108 may store the outputs of the accumulators 120-124 and provide these outputs to a different processing core 100 as inputs or to a global output buffer (not shown) for further processing and/or analysis and/or predictions.

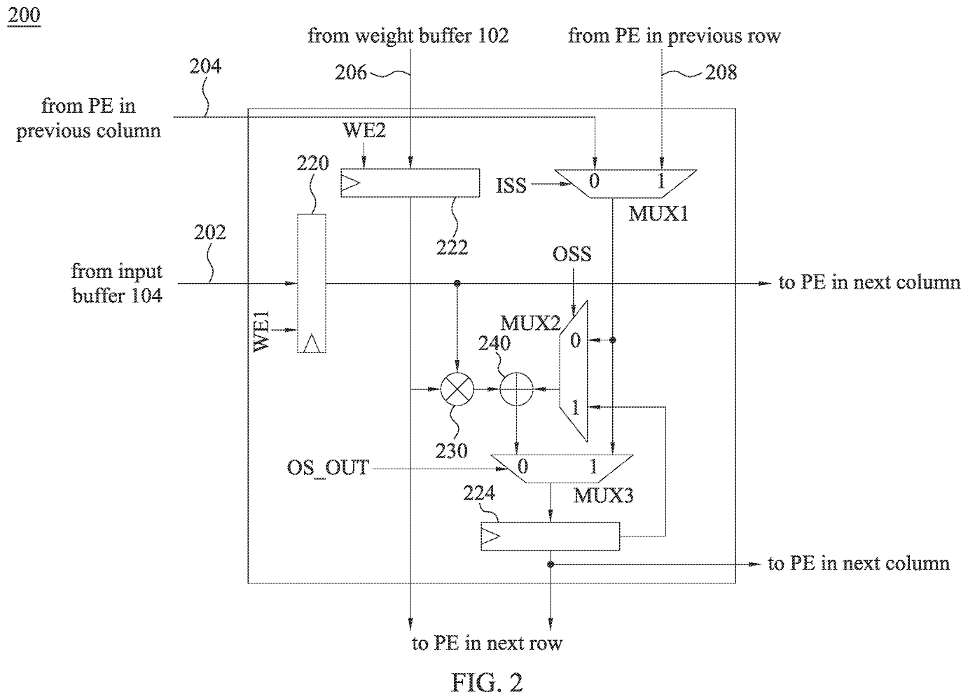

FIG. 2 illustrates an example block diagram of a PE 200, in accordance with some embodiments. Each of the PEs 111-119 of the PE array 110 of FIG. 1 may include (or be implemented as) the PE 200. The PE 200 may include registers (or memories) 220, 222, 224, multiplexors (mux) MUX1, MUX2, MUX3, multiplier 230, and adder 240. The PE 200 may also receive data signals including input 202, previous output 204, weight 206, and previous output 208. The PE 200 may also receive control signals including write enable WE1, write enable WE2, first selector ISS, second selector OSS, and third selector OS_OUT. Although certain components and signals are shown and described in PE 200, embodiments are not limited thereto, and various components and signals may be added and/or removed depending on embodiments. A controller (not shown) may generate and transmit the control signals.

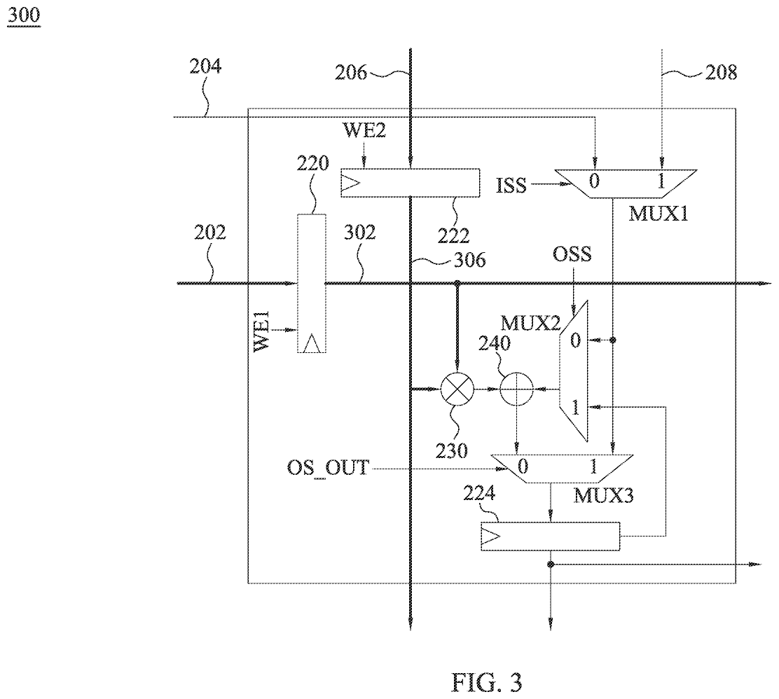

The PE 200 can be configured for various workflows (or flows or modes) of operation. For example, the PE 200 can be configured for input stationary, output stationary, and weight stationary AI workflows. Operations of the PE 200 and how the PE 200 can be configured for the various AI workflows is further described below with reference to FIGS. 3-11.

The register 220 may receive the input 202 (e.g., first, second, and third inputs) from the input buffer 104. The register 220 may also receive the write enable WE1 which can enable writing the input 202 into the register 220. The output of the register 220 may be provided to the PE in the next column (if any) and the multiplier 230.

The register 222 may receive the weight 206 (e.g., first to ninth weights) from the weight buffer 102. The register 222 may also receive the write enable WE2 which can enable writing the weight 206 into the register 222. The output of the register 222 may be provided to the PE in the next row (if any) and the multiplier 230.

The mux MUX1 may receive as inputs the previous output 204 from the PE of the previous column (if any) and the previous output 208 from the PE of the previous row (if any). The output of the mux MUX1 may be provided to the mux MUX2 and the mux MUX3. The first selector ISS may be used to select which of the inputs to the mux MUX1 are provided to the output of the mux MUX1. When the first selector ISS is 0, the previous output 204 may be selected, and when the first selector ISS is 1, the previous output 208 may be selected. Embodiments are not limited thereto, and the encoding of the first selector ISS may be switched (e.g., 1 to select the previous output 204 and 0 to select the previous output 208).

The multiplier 230 may perform a multiplication operation of the output of the register 220 and the output of the register 222. The output of the multiplier 230 may be provided to the adder 240.

The mux MUX2 may receive as inputs the output of the mux MUX1 and an output of the register 224. The output of the mux MUX2 may be provided to the adder 240. The second selector OSS may be used to select which of the inputs to the mux MUX2 are provided to the output of the mux MUX2. When the second selector OSS is 0, the output of the mux MUX1 may be selected, and when the second selector OSS is 1, the output of the register 224 may be selected. Embodiments are not limited thereto, and the encoding of the first selector ISS may be switched (e.g., 1 to select the output of the mux MUX1 and 0 to select the output of the register 224).

The adder 240 may perform an addition operation. The adder 240 may add the output of the multiplier 230 and the output of the mux MUX2. The sum (output) of the adder may be provided to the mux MUX3.

The mux MUX3 may receive as inputs the output of the adder 240 and the output of the mux MUX1. The output of the mux MUX3 may be provided to the register 224. The third selector OS_OUT may be used to select which of the inputs to the mux MUX3 are provided to the register 224. When the third selector OS_OUT is 0, the output of the adder 240 may be selected, and when the third selector OS_OUT is 1, the output of the mux MUX1 may be selected. Embodiments are not limited thereto, and the encoding of the third selector OS_OUT may be switched (e.g., 1 to select the output of the adder 240 and 0 to select the output of the mux MUX1).

The register 224 may receive the output of the mux MUX3. The output of the register 224 may be provided to the PE in the next row (if any), the PE in the next column (if any), and the mux MUX2.

The PE 200 can be reconfigured to support various dataflows, such as weight stationary, input stationary, and output stationary dataflows. In the weight stationary dataflow, the weights are pre-filled and stored in each PE prior to the start of computation such that all of the PEs of a given filter are allocated along a column of PEs. The input feature maps (IFMAPs) are then streamed in through the left edge of the array while weights being stationary in each PE, and each PE generates one partial sum every cycle. The generated partial sums are then reduced across the rows, along each column in parallel to generate one output feature map (OFMAP) pixel per column. Input stationary dataflows are similar to weight stationary dataflows except that the order of mapping. Instead of pre-filling the array with weights, the unrolled IFMAPs are stored in each PE. The weights are then streamed in from the edge and each PE generates one partial sum every cycle. The generated partial sums are also reduced across the rows, along each column in parallel to generate one output feature map pixel per column. Output stationary dataflows refers to the mapping of each PE performing all the computations for one OFMAP while weights and IFMAPs are fed from the edges of the array, which are distributed to PEs using PE-to-PE interconnects. The partial sums are generated and reduced within each PE. Once all the PEs in the array complete the generation of OFMAPs, the results are transferred data out of the array through PE-to-PE interconnects.

As described with reference to FIGS. 3-11, the PE 200 can be reconfigured for the different dataflows so that the same PE can be used for various dataflows.

FIGS. 3-5 illustrate a PE 300 that is configured for the output stationary flow, in accordance with some embodiments. The PE 300 is similar to the PE 200 except that the PE 300 is configured for the output stationary operation flow.

FIG. 3 illustrates a multiply operation of the PE 300, in accordance with some embodiments. The input 202 is saved to the register 220 when the write enable WE1 is high. Then output 302 of the register 220 is forwarded to another PE (e.g., PE of the next column) and also provided as an input to the multiplier 230. The weight 206 is saved to the register 222 when the write enable WE2 is high. Then output 306 of the register 222 is forwarded to another PE (e.g., PE of the next row) or an output buffer (e.g., output buffer 108) and also provided as an input to the multiplier 230. The multiplier 230 performs a multiplication operation on the output 302 and the output 306, and the product is provided as an input to the adder 240. During the output stationary dataflow, the registers 220 and 222 can be updated with a new input activation state (from the input buffer 104) and a new weight (from the weight buffer 102) every time a MAC operation is performed.

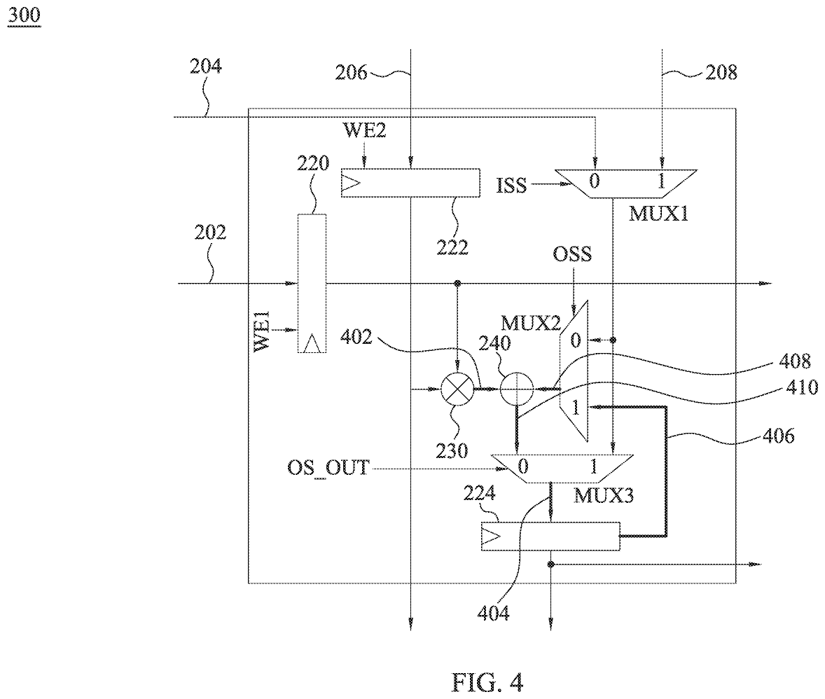

FIG. 4 illustrates an accumulate operation of the PE 300, in accordance with some embodiments. At the conclusion of the multiply operation shown in FIG. 3, the output 402 of the multiplication is provided as an input to the adder 240. Output 406 includes the partial sum stored in the register 224 that is provided to the mux MUX2. The second selector OSS is set to “1” such that the output 406 is provided as output 408 of the mux MUX2. The output 406 is provided to the adder 240 and added with the output 402 such that output 410 is provided to the mux MUX3. And when the third selector OS_OUT is “0”, the output 410 may be provided as an output 404 to the mux MUX3 and as an input to the register 224. Then the register 224 can store the output 404 as the updated MAC result.

The multiply operation of FIG. 3 and accumulate operation of FIG. 4 can be combined to be called MAC operation as discussed above. The MAC operation is repeated for the whole PE array 110. For example, the MAC operations are performed for all of the input activation states and all of the weights that are stored in the input buffer 104 and the weight buffer 102. Depending on embodiments, a bitwidth of the register 224 can vary to accommodate length of the result of the MAC operations for higher precision.

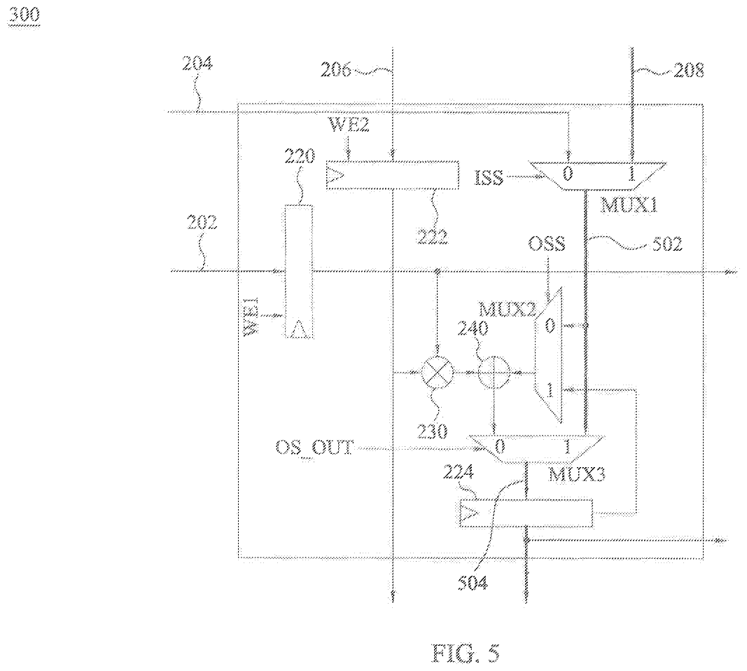

FIG. 5 illustrates a transfer-out operation of the PE 300, in accordance with some embodiments. In general, during the transfer-out operation, the sums stored in the respective registers 224 in each of the PEs 300 are vertically transferred along the corresponding column, ultimately to the accumulators 120-124. For example, the first selector ISS is set to “1” to output the previous output 208 from the mux MUX1 as output 502. The output 502 is then provided to the mux MUX3. The third selector OS_OUT is set to “1” such that the mux MUX3 provides the output 502 as an output 504 to the register 224. After the computation is complete for the whole array (e.g., when the MAC operations for all of the currently stored input activations states and the weights are completed), the stored sum values in the registers 224 for the whole array are vertically transferred to the PE 300 that is located in a lower row until the stored outputs in all of the registers 224 are provided to the accumulators 120-124 between the PE array 110 and the output buffer 108 as shown in FIG. 1.

Accordingly, the PE 200 can be reconfigured so that an AI workload having an output stationary workload can be supported.

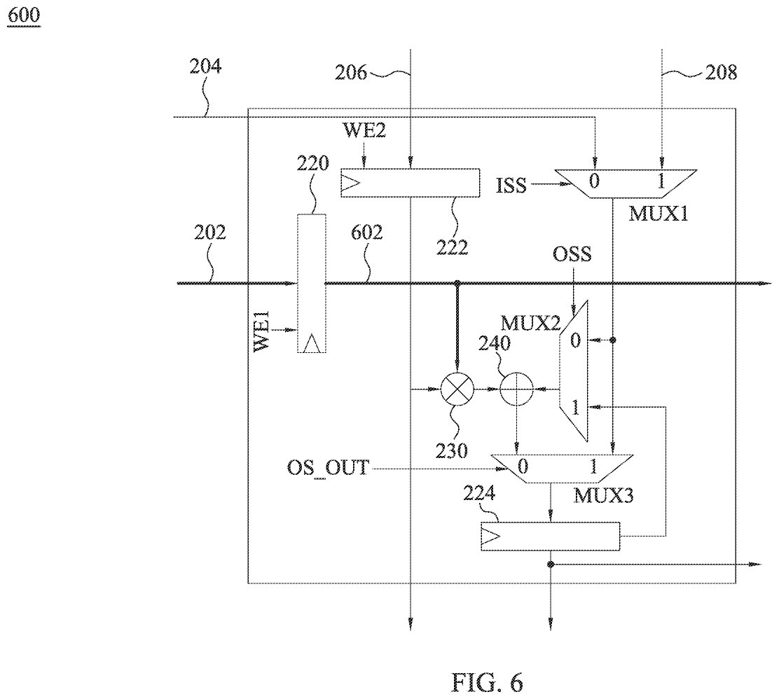

FIGS. 6-8 illustrate a PE 600 that is configured for the input stationary flow, in accordance with some embodiments. The PE 600 is similar to the PE 200 except that the PE 600 is configured for the input stationary operation flow.

FIG. 6 illustrates a preload input activation operation of the PE 600 configured for the input stationary flow, in accordance with some embodiments. The input (e.g., input activation) 202 is provided to the register 220. The write enable WE1 is high such that the input 202 is stored in the register 220. Once the input 202 is written into the register 220, the write enable WE1 is set to low so that the stored input 202 remains stored in the register 220 throughout the MAC operations. The register 220 can output the previous stored input 202 as output 220.

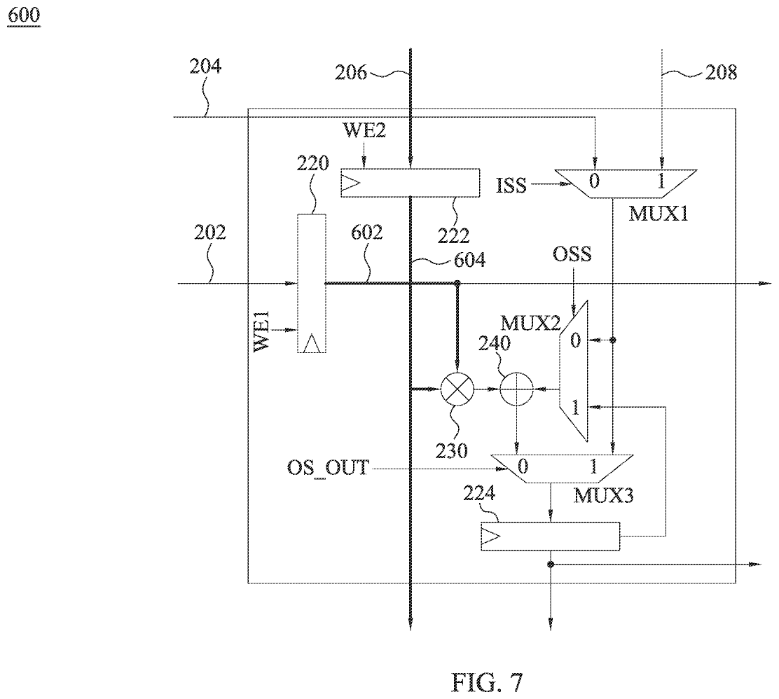

FIG. 7 illustrates a multiply operation of the PE 600 configured for the input stationary flow, in accordance with some embodiments. The output 602 is provided to the multiplier 230. The weight 206 which is provided to the register 222. The write enable WE2 is set to high such that the weight 206 is written to the register 222 every cycle. Then the stored weight 206 may be output as output 604. The weight 604 may be provided to the multiplier 230 as an input. The output 602 and the output 604 may be multiplied by the multiplier 230.

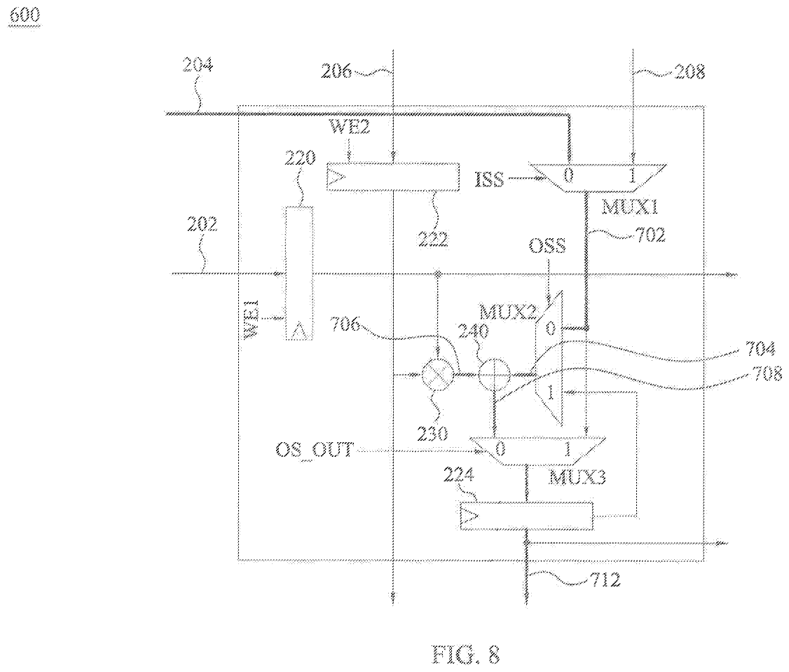

FIG. 8 illustrates an accumulate operation of the PE 600 configured for the input stationary flow, in accordance with some embodiments. The previous output 204 may be provided to the mux MUX1. The first selector ISS may be set to “0” so that the previous output 204 is provided as an output 702 of mux MUX1. The output 702 may be input to the mux MUX2, and when the second selector OSS is set to “0”, an output 704 of the mux MUX2 may be provided to the adder 240. An output 706 from the multiplier 230 may also be provided as an input to the adder 240. The output 706 and the output 704 may be summed to provide an output 708 to the mux MUX3 as the MAC result. The third selector OS_OUT may be set to “0” such that the output 708 is provided to the input of the register 224 and stored therein. Then the output 712 may be provided to the PE 600 of the next row and/or the accumulators 220-224.

Accordingly, the PE 200 can be reconfigured so that an AI workload having an input stationary workload can be supported.

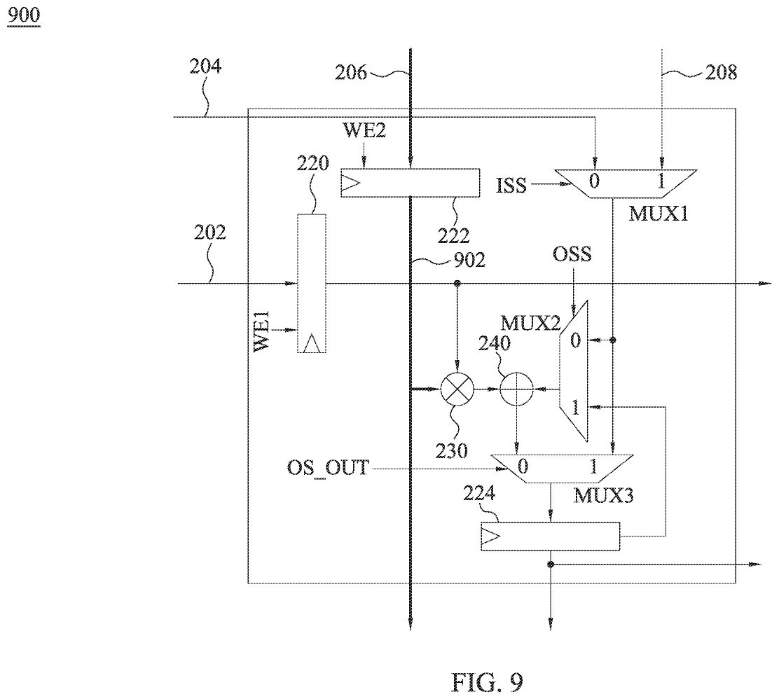

FIGS. 9-11 illustrate a PE 900 that is configured for the weight stationary flow, in accordance with some embodiments. The PE 900 is similar to the PE 200 except that the PE 900 is configured for the weight stationary operation flow.

FIG. 9 illustrates a preload weight operation of the PE 900 configured for the weight stationary flow, in accordance with some embodiments. The weight 206 may be provided to the register 222, and the write enable WE2 may be high so that the weight 206 is loaded into the register 222. Then the weight may be provided as output 902 by the register 222 to the multiplier 230 for subsequent MAC operations until the weight for the register 222 is updated. For example, the write enable WE2 may be set to “0” so that the register 222 retains the weight 206 for all of the MAC operations in the PE array 110 until the weights are updated for a new MAC operation with a new set of input activations and weights.

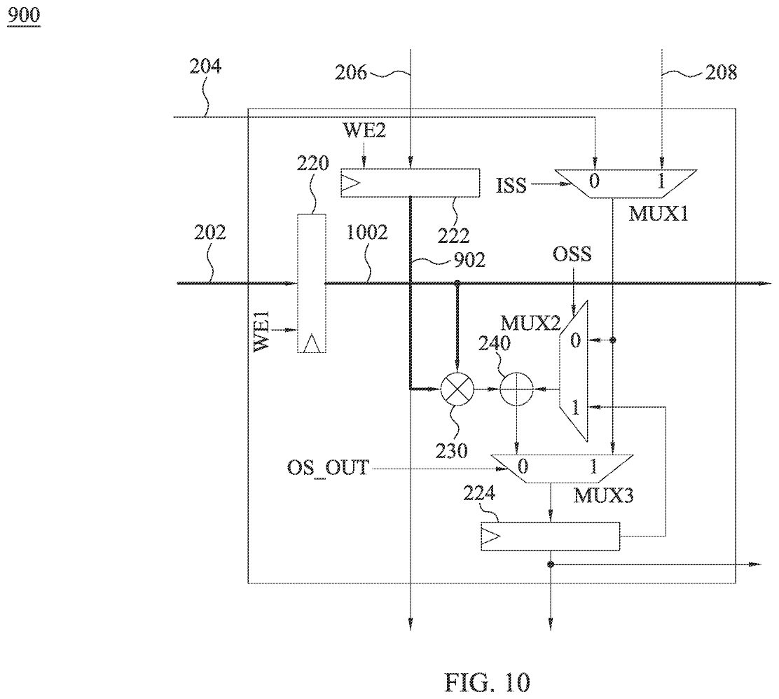

FIG. 10 illustrates a multiply operation of the PE 900 configured for the weight stationary flow, in accordance with some embodiments. The input activation 202 may be provided and stored in the register 220, with the write enable WE1 activated. Then an output 1002 of the register 220 may be provided as an input to the multiplier 230, along with the output 902. The output 902 and the output 1002 may be multiplied using the multiplier 230.

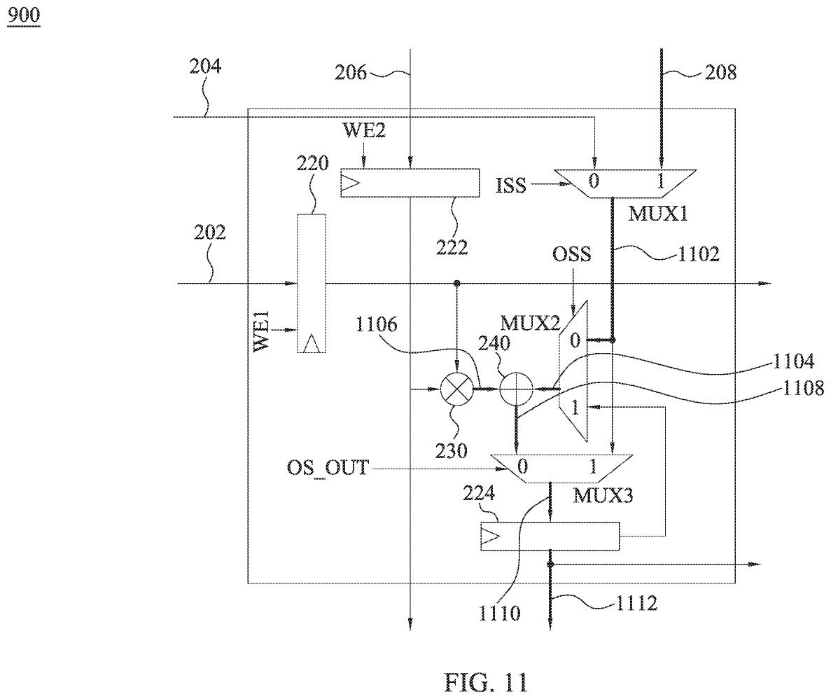

FIG. 11 illustrates an accumulate operation of the PE 900 configured for the weight stationary flow, in accordance with some embodiments. The previous output 208 may be provided as an input to the mux MUX1. The first selector ISS may be set to “1” to output an output 1102 as the output of the mux MUX1. The output 1102 may be input to the mux MUX2, and when the second selector OSS is set to “0”, an output 1104 of the mux MUX2 may be provided to the adder 240. An output 1106 from the multiplier 230 may also be provided as an input to the adder 240. The output 1106 and the output 1104 may be summed to provide an output 1108 to the mux MUX3 as the MAC result. The third selector OS_OUT may be set to “0” such that the output 1108 is provided to the input of the register 224 and stored therein. Then the output 1112 may be provided to the PE 900 of the next row and/or the accumulators 220-224.

Accordingly, the PE 200 can be reconfigured so that an AI workload having an input stationary workload can be supported.

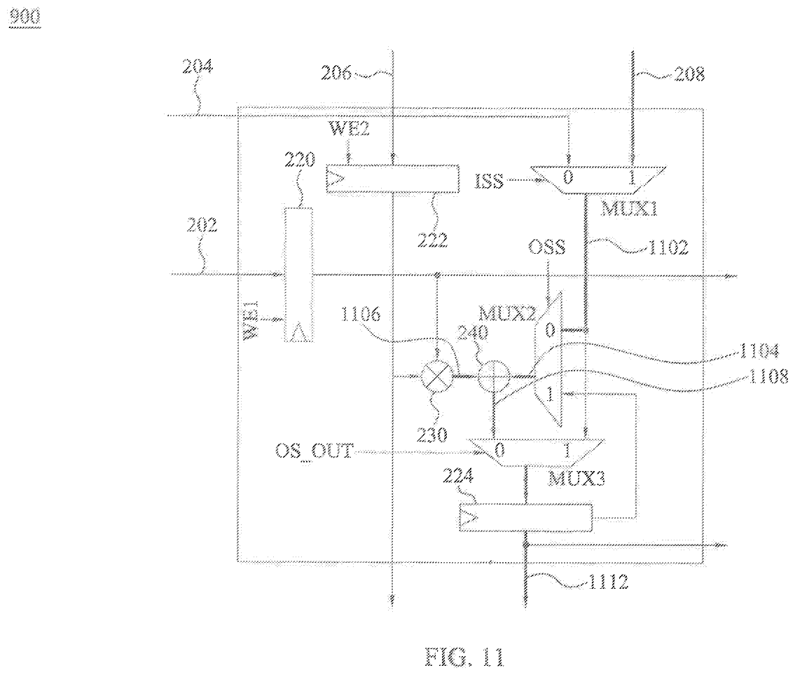

FIG. 12 illustrates a block diagram of a processing core 1200 including a 2×2 PE array, in accordance with some embodiments. The processing core 1200 includes an input buffer 1204 (e.g., input buffer 104), a weight buffer 1202 (e.g., weight buffer 102), an output buffer 1208 (e.g., output buffer 108), and accumulators 1220, 1222 (e.g., accumulators 120, 122). The PEs 1210 and 1212 form a first row and the PEs 1214 and 1216 form a second row. The PEs 1216 and 1214 form a first column and the PEs 1212 and 1216 form a second column. The FIG. 12 shows how the various inputs and outputs of the PEs 1210-1216 are connected with one another, the buffers 1202-1208, accumulators 1220-1222. The processing core 1200 is similar to the processing core 100 of FIG. 1 except that the processing core 1200 includes a 2×2 PE array instead of a 3×3 PE array 110 shown in FIG. 1. Accordingly, repeated descriptions are omitted for clarity and simplicity. Furthermore, although the processing core 1200 includes a 2×2 PE array, embodiments are not limited thereto, and there may be additional PEs in each column and/or row.

The PEs 1210 and 1212 can receive weights from the weight buffer 1202 via weight lights WL1 and WL2. The weights may be stored in the registers 222 of the PEs 1210 and the 1212. The stored weights may be transferred to the PEs 1214 and 1216 via weight transfer lines WTL1 and WTL2 of the corresponding column (e.g., PE 1210 to PE 1214 via weight transfer line WTL1, and PE 1212 to PE 1216 weight transfer line WTL2).

The PEs 1210 and 1214 can receive input activations from the input buffer 1204 via input lines IL1 and IL2. The input activations may be stored in the registers 220 of the PE 1210 and 1214. The input activations may be transferred to the PEs 1212 and 1216 in the corresponding row via input transfer lines ITL1 and ITL 2 (e.g., PE 1210 to PE 1212 via input transfer line ITL1, and PE 1214 to PE 1216 via input transfer line ITL2).

The PEs 1210 and 1212 can provide partial sums and/or full sums from the corresponding registers 224 to the PEs 1214 and 1216 via vertical sum transfer lines VSTL1 and VSTL2 (e.g., PE 1210 to PE 1214 via vertical sum transfer line VSTL1, and PE 1212 to PE 1216 via vertical sum transfer line VSTL2). The PEs 1210 and 1214 can provide partial sums and/or full sums from the corresponding registers 224 to the PEs 1212 and 1216 via horizontal sum transfer lines HSTL1 and HSTL2 (e.g., PE 1210 to PE 1212 via horizontal sum transfer line HSTL1, and PE 1214 to PE 1216 via horizontal sum transfer line HSTL2).

The PEs 1214 and 1216 can provide partial sums and/or full sums from the registers 224 to the corresponding accumulators 1220 and 1222 via accumulator lines AL1 and AL2. For example, the PE 1214 can transfer the partial/full sum to the accumulator 1220 via the accumulator line AL1, and the PE 1216 can transfer the partial/full sum to the accumulator 1222.

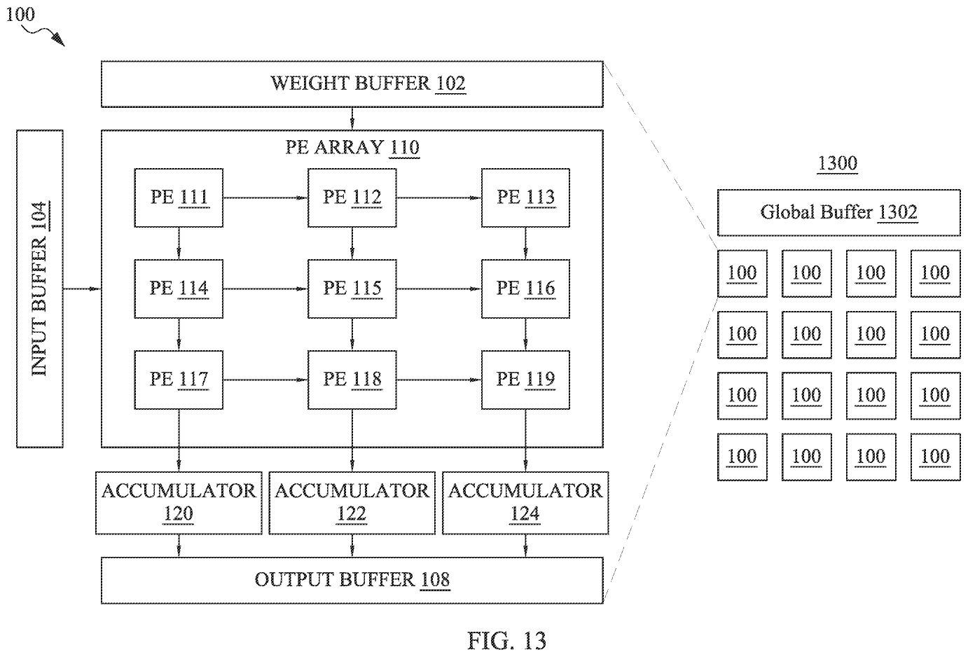

FIG. 13 illustrates a block diagram of an AI accumulator 1300 including an array of processing cores, in accordance with some embodiments. For example, the AI accumulator 1300 may include a 4×4 array of processing cores 100 of FIG. 1. With a multi-core architecture as shown in FIG. 13, the computations for one output feature can be divided to multiple segments, which then can be distributed to multiple cores. In some embodiments, different processing cores 100 can generate the partial sums corresponding to one output feature. Therefore, by interconnecting the cores, the accumulators (i.e., adders and registers) can be reused to sum up the partial sums from each core. A global buffer 1302 can be used to provide the input activations and/or weights for the entire AI accumulator 1300, which can then be stored in the respective weight buffers 102 and/or input buffers 104 of the corresponding processing core 100. In some embodiments, the global buffer 1302 may include the input buffer 104 and/or the weight buffer 102.

In some embodiments, for the output stationary dataflow, the PEs 110 can accumulate a small number of MAC results in the worst case (e.g., highest precision), since the accumulators 120-124 can be used to perform the full accumulate operations that sums the partial sums provided from each column. In some embodiments, the bitwidth of the registers (e.g., registers 220-224) and adders (e.g., adder 240) inside the PE 110 can be made smaller.

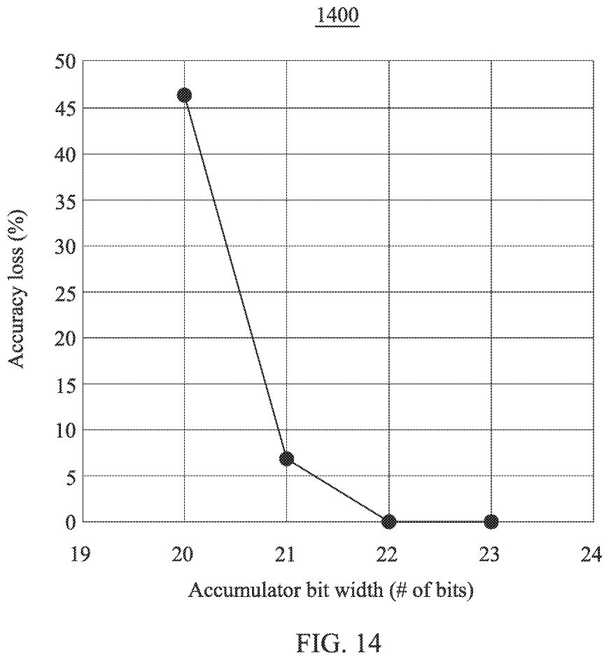

FIG. 14 illustrates a graph 1400 of an accuracy loss as a function of accumulator bit width, in accordance with some embodiments. The x-axis of the graph 1400 includes the accumulator bit width in units of number of bits, and the y-axis includes an accuracy loss in units of percentage (%). The graph 1400 is merely an example to show how the disclosed technology can provide benefits of reconfiguration, area reduction, and energy savings without significant accuracy loss.

Considering an output stationary workflow, varying the computation limit for the accumulation of partial sums shows no accuracy loss down to 23-bit accumulator bit widths. On the other hand, typical AI accelerators may have 30-bit wide accumulators to accommodate the largest number of MAC results to be accumulated. Accordingly, various embodiments can reduce the bitwidth of the registers and adders to a certain extent, instead of sizing it up the bitwidth of the weight stationary accumulators to accommodate the original worst case in output stationary workflows. In some embodiments, the bitwidths may align with the accumulator bitwidths for the input stationary and output stationary workflows. Accordingly, an AI accelerator implementing the disclosed technology can have a reduced area and energy overhead.

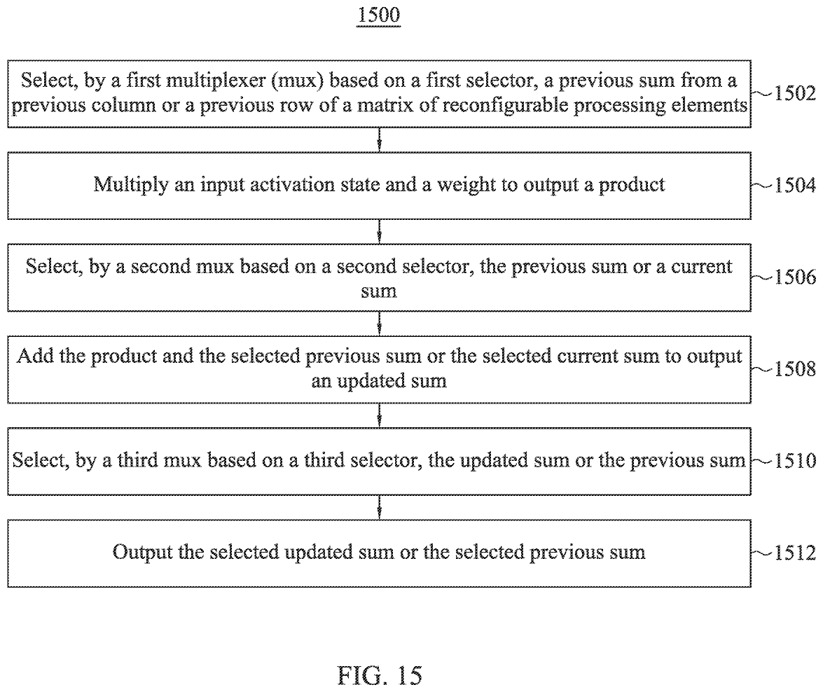

FIG. 15 illustrates a flowchart of an example method 1500 of operating a reconfigurable processing element for an AI accelerator, in accordance with some embodiments. The example method 1500 may be performed with the processing core 100 and/or the processing elements 111-119 or 200. In brief overview, the method 1500 starts with operation 1502 of selecting, by a first mux (e.g., first MUX1) based on a first selector (e.g., first selector ISS), a previous sum (e.g., previous sum 204 or 208) from a previous column or a previous row of a matrix of reconfigurable processing elements (e.g., PE array 110). The method 1500 continues with operation 1504 of multiplying an input activation state (e.g., input 202 or output of register 220) and a weight (e.g., weight 206 or output of register 222) to output a product. The method 1500 continues with operation 1506 of selecting, by a second mux (e.g., mux MUX2) based on a second selector (e.g., second selector OSS), the previous sum (e.g., output of mux MUX1) or a current sum (e.g., output of register 224). The method 1500 continues with operation 1508 of adding the product (e.g., output of multiplier 230) and the selected previous sum or the selected current sum (e.g., output of mux MUX2) to output an updated sum. The method 1500 continues with operation 1510 selecting, by a third mux (e.g., third mux MUX3) based on a third selector (e.g., third selector OS_OUT), the updated sum (e.g., output of adder 240) or the previous sum (e.g., output of mux MUX1). The method 1500 continues with operation 1512 of outputting the selected updated sum or the selected previous sum to a next column or a next row of the matrix of reconfigurable processing elements.

Regarding operation 1502, the selection of the previous sum from the previous column or the previous row depends on the mode of reconfigurable PE. For example, when the reconfigurable PE is in the output stationary mode, the first selector selects the previous sum from the PE in a previous row. When the reconfigurable PE is in the input stationary mode, the first selector selects the previous sum from the PE of the previous column. When the reconfigurable PE is in the weight stationary mode, the first selector selects the previous sum from the PE of the previous row.

Regarding operation 1504, the multiplication is performed on the input activation state and the weight for every mode.

Regarding operation 1506, the selection of the previous sum or the current sum depends on the mode of the reconfigurable PE. For example, when the reconfigurable PE is in the output stationary mode, the second selector selects the current sum. When the reconfigurable PE is in the input stationary mode, the second selector selects the previous sum from the PE of the previous column. When the reconfigurable PE is in the weight stationary mode, the second selector selects the previous sum from the PE of the previous row.

Regarding operation 1508, the addition is performed based on the product from operation 1504 and the selected output of the second mux and the mode of the reconfigurable PE. For example, in the output stationary mode, the product and the current sum are added. In the input and weight stationary modes, the product and the previous sum are added.

Regarding operation 1510, the selection of the updated sum or the previous sum depends on the mode of the reconfigurable PE. For example, when the reconfigurable PE is in the output stationary mode, the third selector selects (1) the output of the adder when performing the accumulate operation of the partial sum and (2) the previous sum when performing the transfer-out operation. When the reconfigurable PE is in the input and weight stationary modes, the third selector selects the output of the adder.

Regarding operation 1512, the output of the updated sum or the previous sum depends on the mode of the reconfigurable PE. For example, when the reconfigurable PE is in the output stationary mode, the previous sum is output. When the reconfigurable PE is in the input or weight stationary modes, the updated sum is output.

In one aspect of the present disclosure, a reconfigurable processing circuit of an AI accelerator is disclosed. The reconfigurable processing circuit includes a first memory configured to store an input activation state, a second memory configured to store a weight, a multiplier configured to multiply the weight and the input activation state and output a product, a first multiplexer (mux) configured to, based on a first selector, output a previous sum from a previous reconfigurable processing element, a third memory configured to store a first sum, a second mux configured to, based on a second selector, output the previous sum or the first sum, an adder configured to add the product and the previous sum or the first sum to output a second sum, and a third mux configured to, based on a third selector, output the second sum or the previous sum.

In another aspect of the present disclosure, a method of operating a reconfigurable processing element for an AI accelerator is disclosed. The method includes selecting, by a first multiplexer (mux) based on a first selector, a previous sum from a previous column or a previous row of a matrix of reconfigurable processing elements, multiplying an input activation state and a weight to output a product, selecting, by a second mux based on a second selector, the previous sum or a current sum, adding the product and the selected previous sum or the selected current sum to output an updated sum, selecting, by a third mux based on a third selector, the updated sum or the previous sum, and outputting the selected updated sum or the selected previous sum.

In yet another aspect of the present disclosure, a processing core of an AI accelerator is disclosed. The processing core includes an input buffer configured to store a plurality of input activation states, a weight buffer configured to store a plurality of weights, a matrix array of processing elements arranged in a plurality of rows and a plurality of columns, a plurality of accumulators configured to receive outputs from a last row of the plurality of rows and sum one or more of the received outputs from the last row, and an output buffer configured to receive outputs from the plurality of accumulators. Each processing element of the matrix array of the processing elements includes a first memory configured to store an input activation state from the input buffer, a second memory configured to store a weight from the weight buffer, a multiplier configured to multiply the weight and the input activation state and output a product, a first multiplexer (mux) configured to, based on a first selector, output a previous sum from a processing element of a previous row or a previous column, a third memory configured to store a first sum and output the first sum to a processing element of a next row or a next column, a second mux configured to, based on a second selector, output the previous sum or the first sum, an adder configured to add the product and the previous sum or the first sum to output a second sum, and a third mux configured to, based on a third selector, output the second sum or the previous sum.

As used herein, the terms “about” and “approximately” generally mean plus or minus 10% of the stated value. For example, about 0.5 would include 0.45 and 0.55, about 10 would include 9 to 11, about 1000 would include 900 to 1100.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A reconfigurable processing circuit of an artificial intelligence (AI) accelerator, the reconfigurable processing circuit comprising:
a first memory configured to store an input activation state;
a second memory configured to store a weight;
a multiplier configured to multiply the weight and the input activation state and output a product;
a first multiplexer (mux) configured to, based on a first selector, output a previous sum from a previous reconfigurable processing element;
a third memory configured to store a first sum;
a second mux configured to, based on a second selector, output the previous sum or the first sum;
an adder configured to add the product and the previous sum or the first sum to output a second sum; and
a third mux configured to, based on a third selector, output the second sum or the previous sum.

2. The reconfigurable processing circuit of claim 1, wherein the first mux is further configured to:
receive a first previous sum from a first reconfigurable processing circuit of a first column as a first input;
receive a second previous sum from a second reconfigurable processing circuit of a different row as a second input; and
based on a first selector, output the first previous sum or the second previous sum as the previous sum.

3. The reconfigurable processing circuit of claim 2, wherein, in a first mode, the first and second memories are further configured to respectively update the stored input activation state and the stored weight each cycle.

4. The reconfigurable processing circuit of claim 3, wherein, in the first mode during an accumulate operation, the second mux is further configured to output the first sum, and the third mux is further configured to output the second sum during an accumulate operation.

5. The reconfigurable processing circuit of claim 4, wherein, in the first mode during a transfer-out operation, the first mux is further configured to output the second previous sum as the previous sum, and the third mux is further configured to output the previous sum.

6. The reconfigurable processing circuit of claim 2, wherein, in a second mode, only the second memory of the first and second memories is configured to update the stored weight each cycle.

7. The reconfigurable processing circuit of claim 6, wherein, in the second mode:
the first mux is further configured to output the first previous sum as the previous sum;
the second mux is further configured to output the previous sum; and
the third mux is further configured to output the second sum.

8. The reconfigurable processing circuit of claim 2, wherein, in a third mode, only the first memory of the first and second memories is configured to update the stored input activation state each cycle.

9. The reconfigurable processing circuit of claim 8, wherein, in the third mode:
the first mux is further configured to output the second previous sum as the previous sum;
the second mux is further configured to output the previous sum to the adder; and
the third mux is further configured to output the second sum.

10. A method of operating a reconfigurable processing element for an artificial intelligence accelerator, comprising:
selecting, by a first multiplexer (mux) based on a first selector, a previous sum from a previous column or a previous row of a matrix of reconfigurable processing elements of the artificial intelligence accelerator;
multiplying an input activation state and a weight to output a product;
selecting, by a second mux based on a second selector, the previous sum or a current sum;
adding the product and the selected previous sum or the selected current sum to output an updated sum;
selecting, by a third mux based on a third selector, the updated sum or the previous sum; and
outputting the selected updated sum or the selected previous sum.

11. The method of claim 10, further comprising determining the first selector, the second selector, and the third selector based on one of three operating modes of the reconfigurable processing element.

12. The method of claim 11, further comprising, during a first mode of the three operating modes, in every processing cycle:
receiving, from an input buffer, an input activation state;
storing, in a first memory, the input activation state;
receiving, from a weight buffer, a weight;
storing, in a second memory, the weight; and
performing the multiplying and the adding.

13. The method of claim 12, wherein, during the first mode, in every processing cycle:
selecting by the first mux includes selecting the previous sum from the previous row;
selecting by the second mux includes selecting the current sum; and
selecting by the third mux includes selecting the updated sum during an accumulate operation or selecting the previous sum during a transfer-out operation after the accumulate operation.

14. The method of claim 11, further comprising, during a second mode of the three operating modes preloading, in a first memory, the input activation state.

15. The method of claim 14, wherein, during the second mode, in every processing cycle:
selecting by the first mux includes selecting the previous sum from the previous column;
selecting by the second mux includes selecting the previous sum; and
selecting by the third mux includes selecting the updated sum.

16. The method of claim 11, further comprising, during a third mode of the three operating modes preloading, in a second memory, the weight.

17. The method of claim 16, wherein, during the third mode, in every processing cycle:
selecting by the first mux includes selecting the previous sum from the previous row;
selecting by the second mux includes selecting the previous sum; and
selecting by the third mux includes selecting the updated sum.

18. A processing core of an artificial intelligence (AI) accelerator, the processing core comprising:
an input buffer configured to store a plurality of input activation states;
a weight buffer configured to store a plurality of weights;
a matrix array of processing elements arranged in a plurality of rows and a plurality of columns, wherein each processing element of the matrix array of processing elements include:
a first memory configured to store an input activation state from the input buffer;
a second memory configured to store a weight from the weight buffer;
a multiplier configured to multiply the weight and the input activation state and output a product;
a first multiplexer (mux) configured to, based on a first selector, output a previous sum from a processing element of a previous row or a previous column;
a third memory configured to store a first sum and output the first sum to a processing element of a next row or a next column;
a second mux configured to, based on a second selector, output the previous sum or the first sum;
an adder configured to add the product and the previous sum or the first sum to output a second sum; and
a third mux configured to, based on a third selector, output the second sum or the previous sum;
a plurality of accumulators configured to receive outputs from a last row of the plurality of rows and sum one or more of the received outputs from the last row; and
an output buffer configured to receive outputs from the plurality of accumulators.

19. The processing core of claim 18, wherein a first row of the matrix array includes a first processing element and a second processing element, and a second row of the matrix array includes a third processing element and a fourth processing element,
wherein the first processing element is configured to output the first sum of the first processing element to the second processing element and the third processing element as the previous sum in the second and third processing elements, and
wherein first mux of the fourth processing element is configured to receive the first sum from the second processing element as a first input and the first sum from the third processing element as a second input.

20. The processing core of claim 19, wherein each of the processing elements of the matrix array is configured to operate in an output stationary mode, an input stationary mode, or a weight stationary mode.
